(19) United States
(12) Patent Application Publication
(10) Pub. No.: US 2003/0016604 A1
(43) Pub. Date: Jan. 23, 2003

(54) System and method for detecting the border of recorded video data

(76) Inventor: David H. Hanes, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/910,970

(22) Filed: Jul. 20, 2001

(51) Int. Cl. H04N 9/74; H04N 9/79; H04N 9/87; G11B 27/00; G11B 5/09; G11B 15/52; G11B 19/02; G11B 20/10; G11B 27/02; G11B 20/22; G11B 20/24; H04N 5/93

(52) U.S. Cl. 369/47.17; 369/47.13; 386/4; 386/52

(57) ABSTRACT

One aspect of the invention is a method for detecting the border of recorded video data. The method comprises analyzing a plurality of video frames. The plurality of video frames comprise recorded video data and undesired data. The method also includes determining whether at least one of the plurality of video frames comprises substantially all undesired data, and identifying the at least one of the plurality of video frames as a border of the recorded video data if the at least one of the plurality of video frames comprises substantially all undesired data.

### TECHNICAL FIELD OF THE INVENTION

The present invention relates in general to video processing systems and more specifically to a system and method for detecting the border of recorded video data.

### BACKGROUND OF THE INVENTION

With the proliferation of optical storage media such as Digital Versatile Discs (DVDs), consumers are often interested in creating discs containing data such as home videos to share with other family members or friends. Consumers may use video devices such as analog and digital camcorders or digital cameras to capture moving pictures as well as still-framed pictures. Such consumer devices may record video data on a wide range of media, typically magnetic videotape, although other types of media, such as rotating magnetic and optical discs, may also be used. In addition, consumers may wish to record data that may be captured or streamed over the Internet.

Consumers may also use these devices to record home movies or home videos involving a wide range of subject matter, and consumers may easily and inexpensively capture large quantities of video material. Unfortunately, traditional methods for preservation of data such as home movies on videotapes do not allow for easy viewing of the movies without, for example, connecting a device such as a camcorder. Moreover, these methods typically do not permit random access during playback of the movies. Furthermore, media such as tape usually deteriorates over time and is bulky and difficult for consumers to share with their friends or family members. The consumer may also not wish to keep portions of video program material that are blank.

### SUMMARY OF THE INVENTION

From the foregoing, it may be appreciated that a need has arisen for determining where one or more borders are in recorded video data. In accordance with the present invention, a system and method for detecting the border of recorded analog video data are provided that substantially eliminate or reduce disadvantages and problems of conventional systems.

One aspect of the invention is a method for detecting the border of recorded video data. The method comprises analyzing a plurality of video frames. The plurality of video frames comprise recorded video data and undesired data. The method also includes determining whether at least one of the plurality of video frames comprises substantially all undesired data, and identifying the at least one of the plurality of video frames as a border of the recorded video data if the at least one of the plurality of video frames comprises substantially all undesired data.

Another aspect of the invention is a system for detecting the border of recorded video data. The system comprises a video data source and a border detection module coupled to the video data source and operable to receive a plurality of video frames. The plurality of video frames comprise recorded video data and undesired data operable to analyze the plurality of video frames. The module is operable to determine whether at least one of the plurality of video frames comprises substantially all undesired data, and identify the at least one of the plurality of video frames as a border of the recorded video data if the at least one of the plurality of video frames comprises substantially all undesired data. The system also comprises a video data storage system operable to store at least a portion of the plurality of video frames.

Another aspect of the invention is an application for detecting the border of recorded video data. The application comprises a border detection module and logic residing on the module. The logic is operable to analyze a plurality of video frames. The plurality of video frames comprise recorded video data and undesired data. The logic is further operable to determine whether at least one of the plurality of video frames comprises substantially all undesired data and to identify the at least one of the plurality of video frames as a border of the recorded video data if the at least one of the plurality of video frames comprises substantially all undesired data.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, and in which:

FIG. 1 is an example of a block diagram of a system that may be used for detecting the border of recorded video data according to an embodiment of the present invention;

FIG. 2 graphically illustrates an example of borders of recorded analog video data according to an embodiment of the present invention; and

FIG. 3 illustrates an example of a method for detecting the border of recorded analog video data according to an embodiment of the present invention.

### DETAILED DESCRIPTION OF THE DRAWINGS

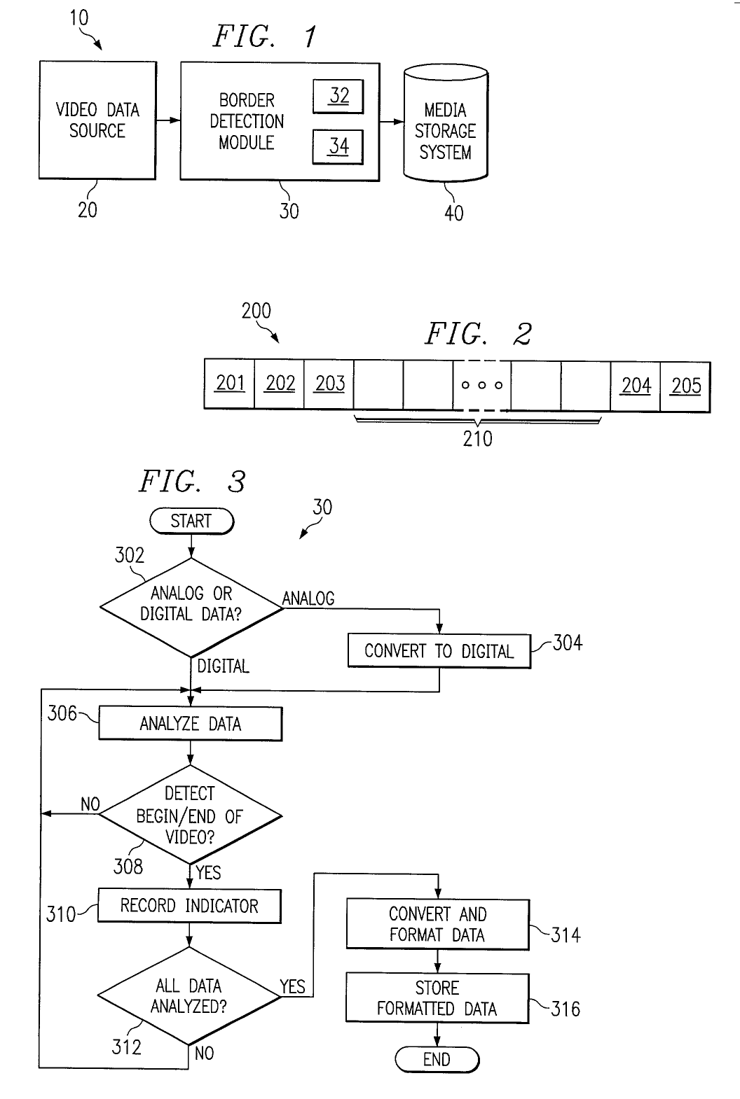

FIG. 1 is an example of a block diagram of a system that may be used for detecting the border of recorded video data according to an embodiment of the present invention. In the embodiment illustrated in FIG. 1, system 10 includes a border detection module 30 and a media storage system 40. One advantage of the present invention is that the invention provides for the automatic processing and storage on optical media of desired data provided by a video data source 20. As one example, the present invention is particularly useful in the recording and/or storage of home videos or other program material that may be contained on videotape or other video storage media, or video data streams from a source such as the Internet. Because the invention provides a system and method for detecting the border of recorded analog video data, the present invention allows a user to easily and quickly separate desired data from undesired data such as video frames that do not contain recorded material (usually displayed on a video output as a solid color or snow, which is a random-pattern black and white image). The present invention also allows a user to conveniently store the desired video data in an easy and efficient manner on optical media such as a DVD disc. Accordingly, the present invention obviates the need for a user to manually screen or review an entire video tape to view desired video data.

Video data source 20 provides video data to border detection module 30. Video data sources include any of a wide range of systems and devices now known in the art or that may be developed in the future. For example, video data source 20 may provide video data that is contained on storage media such as video tape (not explicitly shown) or a source that may produce video data continuously or “on the fly” as the video source is being used. Video data source 20 may be a digital or analog video camcorder and/or other recorder, a videocassette recorder (VCR), or other source of video data, such as streamed data from the Internet. Video data may be digital video data, analog video data, or a combination of both.

Border detection module 30 operates in conjunction with logic 32 to detect a border of recorded video data and to transform video data received from video data source 20 into formatted data that may be stored on optical media (e.g., a DVD disc) using media storage system 40. For example, in the embodiment shown in FIG. 1, border detection module 30 may access and/or include programs or software routines of logic 32, depending on the particular application. For example, these routines may include, but are not limited to, compression, encoding, and/or border detection routines. Border detection module 30 may be connected to, or include, a memory system, such as a cache or random access memory (RAM) 34, suitable for storing all or a portion of these programs or routines and/or temporarily storing video or other data during various processes performed by border detection module 30. Memory may be used, among other things, to support real-time analysis and/or processing of video data. Real-time processing may be defined as the speed at which video data is being recorded to optical storage media such as a DVD. For example, when using an analog camcorder, real-time may be defined as the speed at which a movie is normally played back. Then, memory 34 would be suitable for storing the various routines and/or temporarily storing the video data during the various processes performed by system 10. Alternatively, or in addition, border detection module 30 may also include, or be coupled to, logic 32 that may be implemented in a variety of hardware and/or firmware configurations, including but not limited to, compression and/or encoding cards (not explicitly shown).

Border detection module 30 may also, in a particular embodiment, control the overall function and operation of system 10. For example, border detection module 30 may be a general-purpose programmable computer, such as the ubiquitous personal computer (PC), which is well known in the art and readily commercially available. Alternatively, border detection module 30 may be more a task-specific or custom-designed processing system that may be specifically configured to interface with various devices and to perform in accordance with the methods described herein. Any encoding may be performed in real-time; that is, as the data is being stored to the media. For example, encoding may be performed using a variety of methods, including hardware support such as a capture or compression card. As processor speeds increase, it may be more advantageous to perform digitization and/or compression steps using software resident on one or more border detection modules 30.

Media storage system 40 is operable to store data on optical storage media (not explicitly shown), such as a compact disc (CD) or Digital Versatile Disc (DVD), and is operable to couple with, and stores indexed, formatted data received from, border detection module 30. The indexed, formatted data stored on the optical media may then be viewed as desired using any playback device such as a DVD movie player or DVD-ROM drive (not explicitly shown). Any DVD media storage system may then be used to store data on compatible optical storage media such as a DVD disc, which may then be played back on any of a wide range of DVD playback systems that are also well-known and readily commercially available. Alternatively, other types of media storage systems 40 that are now known or that may be developed in the future may be substituted for media storage system 40 to store data on optical storage media. Storage of the indexed, formatted data onto optical media such as a DVD provides the advantage of associating image files with a particular point in any video. For example, a DVD video playback device may display images using an indexed “menu” or “search” capability which allows a user to access that image at an appropriate place in the video data. The present invention provides the advantage of allowing automatic detection of a border of recorded video data.

While the embodiment illustrated in FIG. 1 and described herein is used to store formatted data on optical storage media such as DVD, other storage media currently known in the art or that may be developed in the future may also be used. In addition, although video data is described herein as either analog or digital data that may be received and/or stored in certain formats such as, but not limited to, VHS, beta, 8 mm, high-8, VHS-C, Moving Picture Experts Group (MPEG), Joint Photographic Experts Group (JPEG), Universal Disc Format (UDF), or Video Object Format (VOB), RF, S-video, other formats or data structures may also be used. Thus, the method and system of the present invention should not be limited to the particular storage media, formats, and/or data storage structures that are shown and described herein.

Analog video data may be received from a video data source 20 by any of a wide range of analog video data transmission systems that are well-known in the art, such as coaxial cable or S-video cable. Analog video data may also be in one of many formats such as NTSC, PAL, or video. On the other hand, digital video data may be received using a variety of bus systems such as, but not limited to, a system utilizing the 1394 bus protocol or the universal serial bus (USB) protocol. In a particular embodiment, digital video data may be organized in any of a wide variety formats or standards, such as MPEG, JPEG, or VOB. Digital video data received from video data source 20 may be uncompressed, or compressed according to respective compression formats such as MPEG and JPEG formats. As one example, data organized using the MPEG format is typically compressed.

FIG. 2 graphically illustrates an example of borders of recorded video data according to an embodiment of the present invention. A plurality of video frames of 200 includes video frames 210 of recorded video data, each having a plurality of pixels. In a particular embodiment, video frames 201-203 may precede video frames 210 and video frames 204 and 205 may follow video frames 210. The pixels included in video data 200 may be desired data, which is the data content intended to have been captured, or undesired data, which is data included in frames that did not record data content. For example, the plurality of video frames 210 includes recorded data content which is substantially all desired data, and video frames 201-203 and 204-205 do not included unrecorded data, and thus included substantially all undesired data.

The value of “substantially all” is a value relative to a total number of pixels in a video frame, and may vary from application to application. For example, in a particular embodiment, one or more video frames may be analyzed to determine at what point all of the pixels within a frame, or a majority thereof, are a single color. Depending on the application, substantially all may be a predetermined value, such as 90% of the pixels within a video frame, and that is, for example, defined by a user. Many other values for “substantially all” may be determined by a variety of methods. As illustrated in FIG. 2, two of the plurality of video frames of the recorded video data 200 may each be identified respectively as a border 203 and a border 204. One method for identifying at least one of the plurality of video frames of the recorded video data 200 as a border 203 is discussed in conjunction with FIG. 3.

FIG. 3 illustrates an example of a method for detecting the border of recorded video data according to an embodiment of the present invention. Generally, the method includes analyzing a plurality of video frames in recorded video data, where the recorded data includes desired data and undesired data. The method also includes determining whether at least one of the plurality of video frames comprises substantially all undesired data. If so, the method includes identifying at least one of the plurality of video frames as the border of the recorded video data. Various embodiments may utilize fewer or more steps, and the method may be performed using a number of different implementations, depending on the application.

The method begins in step 302, where border detection module 30 may receive video data from video data source 20. Analog video data is converted to digital video data in step 304 by one of a variety of methods. For example, the conversion may be performed by any of a wide range of analog-to-digital conversion functions such as those that are typically found in a video capture card provided in a PC. After the conversion in step 304, the method may proceed to step 306.

In step 306, digital video data may be analyzed. For example, in step 306, the data may be analyzed by providing for the automatic detection and identification of certain video frames, such as, for example, detection of a border of the recorded video stream. For example, video frames of recorded video data 200 are analyzed to determine a border between desired data and undesired data. That is, at least one of the plurality of frames may be identified as the border of captured video data, and desired data may be recorded, stored, indexed, and otherwise processed according to the needs of the individual or entity. The undesired data as illustrated by video frames 201-205 as shown in FIG. 2 may be discarded or ignored during subsequent processing of the received video data.

This step may be performed using a variety of methods. For example, in a particular embodiment, one or more frames may be analyzed in real-time. This analysis may be performed before or after the data is digitized, or after it has been compressed. One such method includes utilizing histograms to determine whether a frame includes any recorded video data. As an example, in a particular embodiment, one or more video frames may be analyzed to determine at what point substantially all the pixels within a frame, such as a majority thereof, are a single color. For example, usually with most analog video sources, the undesired data, such as video frames 204 and 205 as illustrated in FIG. 2, may appear to a viewer as a video output having a solid color such as blue or black, or as a random pattern of black and white pixels (“snow”). The method may generate a histogram comprising a quantity of pixels counted for each pixel bin value for the pixel data by any known method. For example, where pixel values range from 0 to 255, 256 histogram bins may be created. The method may then determine a desired threshold to determine whether substantially all of the pixels are undesired data by a variety of methods. For example, the quantity of pixels within each of the bins may be summed, and where the quantity of pixels in a single of the bins, a plurality of closely-valued bins, or select bins (such as those whose values represent black and white) exceeds a certain percentage of the overall number of pixels, the method may determine that the video frame is substantially all undesired data.

Alternatively or in addition, other parameters may also be used to determine the border of the recorded video data. For example the method may be tailored to assume that, after a certain time threshold has elapsed as measured over a number of video frames 210 as illustrated in FIG. 2, there is no further desired data. As another example, the analysis may also include evaluating the plurality of video frames after data compression has been performed. In one embodiment, the method includes an analysis of MPEG motion compensation vectors to determine whether little or no motion is present in one or more frames. MPEG refers to the name of family of standards used for coding audio-visual information (e.g., movies, video, music) in a digital compressed format. The method may utilize a variety of thresholds to determine whether a frame includes desired or undesired data, where a predetermined or dynamically determined amount of motion is detected in the frame relative to another frame.

Movement of objects between two video frames may be detected by, for example, pixel, object, or region of one or more frames using a variety of known methods. For example, in some applications, MPEG motion compensation vectors may be used to obtain rates of movement for an object. These rates may be expressed in terms of dx/dt and/or dy/dt, where x and y are spatial coordinates within a frame. Alternatively or in addition, subtraction techniques may be used to determine distances dx and dy by subtracting data values between two or more video frames. Motion vectors may be used with a given accuracy in pixels from a reference field 1/field 2 to a predicted field 1/field 2 and, to exploit temporal redundancy, motion estimation and compensation may be used for prediction.

In step 308, the method queries whether the border of the recorded video stream was detected. If not, the method returns to step 306 to continue data analysis. If so, the method proceeds to step 310, where a frame notation or indicator may be produced as an identifier of the border and stored along with the video data as indexed video data using one of many indexing routines and methods. In addition or alternatively, recording may be stopped until valid video re-appears, or blank video may be deleted. The method queries in step 312 whether all data has been analyzed. If not, the method returns to step 306. If all data has been analyzed, the method proceeds to step 314.

In step 314, all or a portion of the video data, such as the desired data, may be converted and formatted according to a wide variety of video data formats that are generally advantageous in the subsequent storage of video data on a selected medium such as DVD. For example, in a particular embodiment, indexed data may be formatted in VOB format, currently the standard for DVD movies. Other formats now known or that may be developed in the future may be used.

In step 316, the formatted data may be stored on optical storage media such as a DVD disc using media storage system 40. In a particular embodiment, this step may include encoding or formatting the video data into a particular format or data structure that may be used to store the video data on a medium associated with optical storage system 40. For example, video data may be formatted or encoded in either VOB or UDF format for convenient storage on an optical storage medium associated with media storage system 40. Encoding and formatting are changes well known in the art and can be easily provided for by persons having ordinary skill in the art after having becoming familiar with the teachings in the present invention.

Moreover, step 316 may include the function of compressing the video data where desired. For example, decompression may be used to decompress compressed video data appropriately where indexing in step 314 may be preferably performed on uncompressed video data. On the other hand, step 316 may also include traditional compression techniques to compress uncompressed video data. As a result, the particular functionality of compression hardware or software will differ depending on the application and ordering of the steps for processing received video data. Moreover, routines for compressing and/or decompressing video data in accordance with any of a wide variety of digital compression protocols are well known in the art and can easily be provided by those having ordinary skill in the art after having become familiar with the teachings of the present invention.

Thereafter, the data stored on the DVD disc may be viewed on a conventional DVD movie player, and the user is free from having to manually screen or review an entire video tape to view desired video data. The present invention contemplates performing steps during the method in various order and thus the present invention should not be regarded as limited to processes or that certain steps are performed in any particular order in the method. For example, steps 306 - 316 may be performed on many types of data and, thus may be placed at any convenient position in the method. For example, steps may be performed on analog data or converted video data such as MPEG or JPEG data, and may be located directly following step 302, step 304, or step 314, depending on the application. Still other configurations are possible, depending on the types of data existing at any particular stage during the method, and on the particular implementation of system 10.

What is claimed is:

1. A method for detecting the border of recorded video data, comprising:
analyzing a plurality of video frames, the plurality of video frames comprising recorded video data and undesired data;
determining whether at least one of the plurality of video frames comprises substantially all undesired data; and
identifying the at least one of the plurality of video frames as a border of the recorded video data if the at least one of the plurality of video frames comprises substantially all undesired data.

2. The method of claim 1, further comprising digitizing at least a subset of the plurality of video frames.

3. The method of claim 1, further comprising compressing the at least a subset of the digitized plurality of video frames.

4. The method of claim 1, further comprising formatting the at least a subset of the digitized plurality of video frames.

5. The method of claim 1, further comprising storing at least a subset of the plurality of video frames on optical storage media using a media storage system.

6. The method of claim 1, further comprising receiving at least a subset of the plurality of video frames from one of the group consisting of a video camcorder, video recorder, and a digital data stream.

7. The method of claim 1, further comprising:
creating a histogram of at least one of the plurality of video frames; and
determining from the histogram whether the at least one of the plurality of video frames comprises substantially all undesired data.

8. The method of claim 1, further comprising:
analyzing motion vectors created from the at least one of the plurality of video frames; and
determining from the motion vectors whether the at least one of the plurality of video frames comprises substantially all undesired data.

9. A system for detecting the border of a video stream, comprising:
a video data source; and
a border detection module coupled to the video data source and operable to receive a plurality of video frames, the plurality of video frames comprising recorded video data and undesired data,
analyze the plurality of video frames,
determine whether at least one of the plurality of video frames comprises substantially all undesired data, and
identify the at least one of the plurality of video frames as a border of the recorded video data if the at least one of the plurality of video frames comprises substantially all undesired data.

10. The system of claim 9, further comprising a media storage system operable to store at least a portion of the plurality of video frames.

11. The system of claim 10, wherein the media storage system comprises optical storage media.

12. The system of claim 9, wherein at least a subset of the plurality of video frames is received from one of the group consisting of a video camcorder, video recorder, and a digital data stream.

13. The system of claim 9, wherein the border detection module is further operable to determine by:
creating a histogram of at least one of the plurality of video frames; and
determining from the histogram whether the at least one of the plurality of video frames comprises substantially all undesired data.

14. The system of claim 9, wherein the border detection module is further operable to determine by:
analyzing motion vectors created from the at least one of the plurality of video frames; and
determining from the motion vectors whether the at least one of the plurality of video frames comprises substantially all undesired data.

15. An application for detecting a border of recorded video data comprising:
a border detection module;
logic residing on the module, the logic operable to receive a plurality of video frames, the plurality of video frames comprising recorded video data and undesired data,
analyze the plurality of video frames,
determine whether at least one of the plurality of video frames comprises substantially all undesired data, and
identify at least one of the plurality of video frames as a border of the recorded video data if the at least one of the plurality of video frames comprises substantially all undesired data.

16. The application of claim 15, wherein the logic residing on the module comprises at least one software application.

17. The application of claim 15, wherein the logic residing on the module comprises firmware.

18. The application of claim 15, wherein the logic is operable to determine by:
creating a histogram of at least one of the plurality of video frames; and
determining from the histogram whether the at least one of the plurality of video frames comprises substantially all undesired data.

19. The application of claim 15, wherein the logic is further operable to cause recording of the desired data onto an optical storage medium using a media storage system.

20. The application of claim 15, wherein the logic is further operable to determine by:
analyzing motion vectors created from the at least one of the plurality of video frames; and
determining from the motion vectors whether the at least one of the plurality of video frames comprises substantially all undesired data.

21. The application of claim 15, wherein substantially all is determined by a value defined by a user.

22. The application of claim 15, wherein at least a subset of the plurality of video frames is received from one of the group consisting of a video camcorder, video recorder, and a digital data stream.
